(19) United States
(12) Patent Application Publication
(10) Pub. No.: US 2003/0103146 A1
(43) Pub. Date: Jun. 5, 2003

(54) Online relay-broadcasting system

(76) Inventor: Sug-Bae Kim, Republic of Korea (KR)

Correspondence Address: Frank R Occhiuti, Fish & Richardson, 225 Franklin Street, Boston, MA, 02110-2804, US

(21) Appl. No.: 10/258,425

(22) PCT Filed: Apr. 24, 2001
(86) PCT No.: PCT/KR01/00686

(30) Foreign Application Priority Data
Apr. 24, 2000 (KR) 2000/21663

(51) Int. Cl. H04N 7/173; G06F 15/16

(52) U.S. Cl. 348/211.11; 348/211.3; 709/205; 725/86

(57) ABSTRACT

The invention relates to an online relay-broadcasting system which enables consumers to enjoy viewing not only regular TV images, but also selectively viewing the images output from a camera selected out of plurality of cameras set up around a stadium by combining into three-dimensional dynamic images while an event is relay-broadcasting on the internet, so that consumers can enjoy the reality of a game by directly editing all the online images captured and out by a plurality of digital cameras set up around a stadium without the labor force and cost needed for relay-broadcastings as well as those which are relay-broadcasted by a TV broadcasting station.

### BACKGROUND OF THE INVENTION

1. Filed of the Invention

The present invention relates to an online relay-broadcasting system, and more particularly to an online relay-broadcasting system which enables consumers to enjoy viewing not only regular TV images, but also selectively viewing the images output from a camera selected out of a plurality of cameras set up around a stadium by combining into three-dimensional dynamic images while an event is relay-broadcasting on the internet.

2. Description of the Prior Art

In general, there are two ways to see an athletic game by directly going to the stadium where the game is taking place or viewing it on TV.

In seeing the game on TV, consumers takes only images edited by a broadcasting station airing the game without any other choice. However, if the game is not to be broadcasted by a TV broadcasting station, the only way to see the game is to actually go to see it.

However, some popular athletic games like professional baseball games have recently started to be relay-broadcasted on the internet along with the great expansion of online services. Thus, the relay-broadcasting of sports games on the internet is at its initial, negligible stage now.

Currently, the online broadcasts have been made in two methods, that is, displaying the same images or contents of a game as a TV broadcasting station airs, and providing data summarizing the procession and result of a game with Tables or animation graphics.

Even if it may be effective in taking images of relay-broadcasting programs on the internet at the place where consumers have difficulty in receiving TV programs with the TV set, there is a problem in the conventional online relay-broadcasting system in that viewers can have only the images of a game edited and transmitted by a TV broadcasting station even on the internet, just like simply watching TV.

Also, there is another problem in the conventional online relay-broadcasting system in that even if Tables or animation graphics providing data about procession and result of a game through the internet may make viewers a little amused about the game, they are not real images, but simple pictures of the game not to make the viewers feel the reality of the game taking place in a stadium.

### SUMMARY OF THE INVENTION

Therefore, it is an object of the present invention to solve the aforementioned problems and provide an online relay-broadcasting system, which controls to transmit images captured by a plurality of digital cameras set up around a stadium so that consumers can selectively view not only the images edited for viewers by a TV broadcasting station, but also those directly output from cameras set up places as the consumers wish to feel the reality of an event happening in the stadium.

In addition, it is another object of the present invention to provide a relay-broadcasting system on the internet, which gives an effect of three-dimensional dynamic images taken by a plurality of digital cameras that show around the stadium at a predetermined interval of time.

In order to accomplish the aforementioned object of the present invention, there is provided an online relay-broadcasting system comprising:

a plurality of digital cameras set up around a stadium;

an image input unit for receiving images output from the cameras;

an intermediate server for re-setting to selectively transmit the images input from the image input unit according to the requests of consumers contacting on the internet; and

a computer for enabling consumers to receive regular images of TV broadcasting programs and select images transmitted through the intermediate server on the internet.

At this time, the intermediate server is constructed to individually control a plurality of digital cameras with the image input unit for carrying on relay-broadcasts.

In addition, the digital cameras and the image input unit are inter-connected in either cable or wireless networking method.

The consumers' computer has functions of selecting a desired camera out of a plurality of cameras set up around a stadium, editing relay-broadcasting images, and selectively viewing three-dimensional dynamic images.

The online relay-broadcasting system thus constructed is advantageous in enabling consumers to feel the reality of an event happening in a stadium because the system can re-set desired images on the computer through which consumers not only watch images input from a TV broadcasting station, but also select an image output from a predetermined camera as they wish to simultaneously view a variety of images of the event captured and output from a plurality of movable digital cameras set up around a stadium.

### BRIEF DESCRIPTION OF THE DRAWINGS

Objects and aspects of the invention will become apparent from the following description of a preferred embodiment with reference to the accompanying drawings in which:

FIG. 1 is a block diagram for illustrating an online relay-broadcasting system in accordance with the present invention;

FIG. 2 shows consumer's computer in accordance with the present invention; and

FIG. 3 is a block diagram for illustrating an online relay-broadcasting system in accordance with a preferred embodiment of the present invention.

### DETAILED DESCRIPTION OF THE PRESENT INVENTION

Objects and aspects of the present invention will become apparent from the following detailed description of a preferred embodiment with reference to the accompanying drawings.

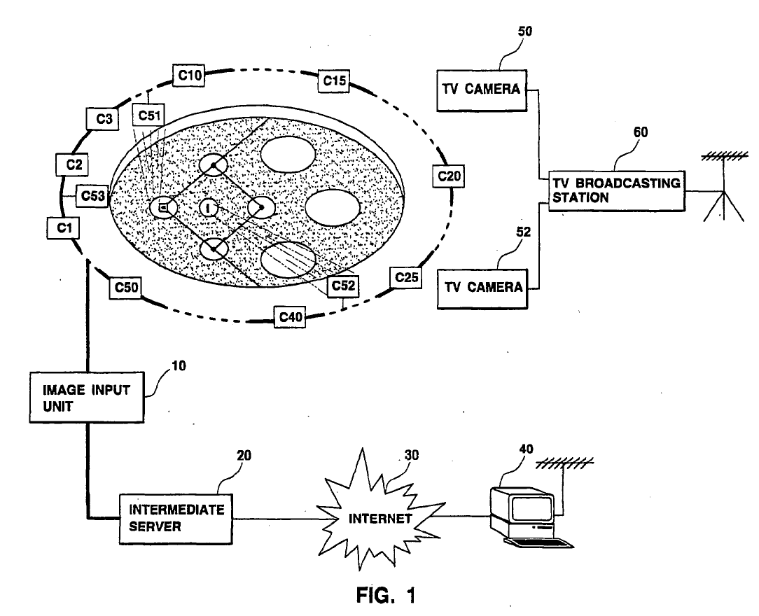

FIG. 1 is a block diagram for illustrating an online relay-broadcasting system in accordance with an embodiment of the present invention.

As shown in FIG. 1, the online relay-broadcasting system of the present invention comprises: a plurality of digital cameras C1˜C53 set up around a stadium; an image input unit 10 for receiving images output from the cameras C1˜C53; an intermediate server 20 for re-setting to selectively transmit the images input from the image input unit according to requests of consumers contacting on the internet; and computers 40 for enabling consumers to receive TV programs and select images transmitted through the intermediate server on the internet.

At this time, the digital cameras C1˜C53 can directly take and transmit the dynamic images, thereby reducing a step of turning static images into dynamic images.

In addition, the first through fifty third cameras C1˜C53 digital cameras and the image input unit 10 are inter-connected in a cable or wireless networking method.

Furthermore, TV cameras 50, 52 are stationed at a plurality of places of the stadium for a TV broadcasting station. Thus, the TV broadcasting station edits the images of a game captured by the TV cameras 50, 52 and then transmits them in the wireless method.

At this time, all the images captured by a plurality of digital cameras C1˜C53 set up around the stadium are also transmitted to the image input unit 10. Then, the intermediate server 20 transmits an image signal input from the image input unit 10 to provide the image captured by a digital camera in response to a choice of each consumer who is in contact with the intermediate server 20 on the internet 30.

In other words, the first through fifty-third digital cameras C1˜C50 are installed around a baseball stadium at a predetermined interval of angle and distance for identically focusing on a predetermined object of the stadium. In addition, the fifty-first, fifty second and fifty third digital cameras 51, 52, 53 respectively take pictures, zooming in actions of a pitcher, a catcher and spectators. As a result, all those digital cameras C1˜C53 are necessary to provide various images of a game.

Accordingly, consumers can simultaneously see a baseball game on TV with a main image relay-broadcasted by a TV broadcasting station and an auxiliary image of pitcher's or spectators' actions respectively captured and zoomed in by the fifty-first or fifty-third digital cameras C51, C53.

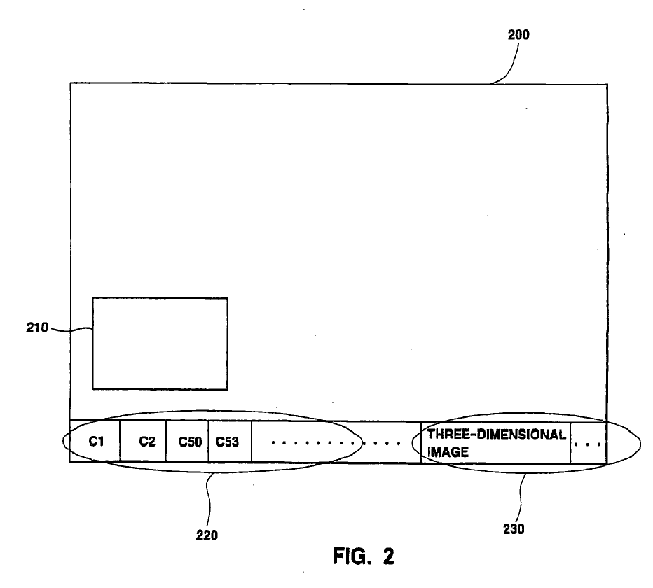

As shown in FIG. 2, even if the main image of a TV set shows a pitcher's throwing a ball, a consumer may simultaneously view the image of a catcher captured and zoomed in at a desired direction by the fifty-second digital camera C52 as he or she selects it as either main image receiver 200 or auxiliary image receiver 210 of the computer with a camera selection unit 220, so that the consumer can enjoy both images of pitcher's and catcher's actions at the same time in a multi-casting method.

In addition, if a consumer desires to view various aspects of a game with a function selection unit 230, just like looking around at a predetermined part of the stadium as its center point, all the digital cameras C1˜C50 set up around the stadium are re-set to sequentially input their images through the image input unit 10 to the intermediate server 20 at a predetermined interval of time of 0.5 seconds, so that the consumer can see three-dimensional dynamic images, just like looking around the stadium.

In other words, the first through fiftieth digital cameras C1˜C50 are installed around the stadium, focusing on an identical object at a predetermined angle of 7.2 degree therebetween. On the other hand, if a consumer wishes to see images moving around up to 180 degree, the first through twenty-fifth digital cameras C1˜C25 can be rearranged at a predetermined interval of time.

At this time, the function selection unit 230 can be set with a menu for a consumer to choose a predetermined interval of time, for instance, 0.5, 1 or two seconds to sequentially view images turning around a stadium at the same time.

On the other hand, even if there is no scheduled TV relay-broadcasting program of a baseball game, a consumer can get in contact with the intermediate server 20 on the internet 30 to respectively select and view pitcher's images of the fifty-first digital camera C51 for the main image receiver 200 and catcher's images of the fifty-second digital camera C52 for the auxiliary image receiver 210. In addition, if the fifty-third digital camera C53 is selected for the auxiliary image receiver 210, the consumer can enjoy the reality of the game, viewing the happenings of spectators' seats along with the exciting atmosphere of the game.

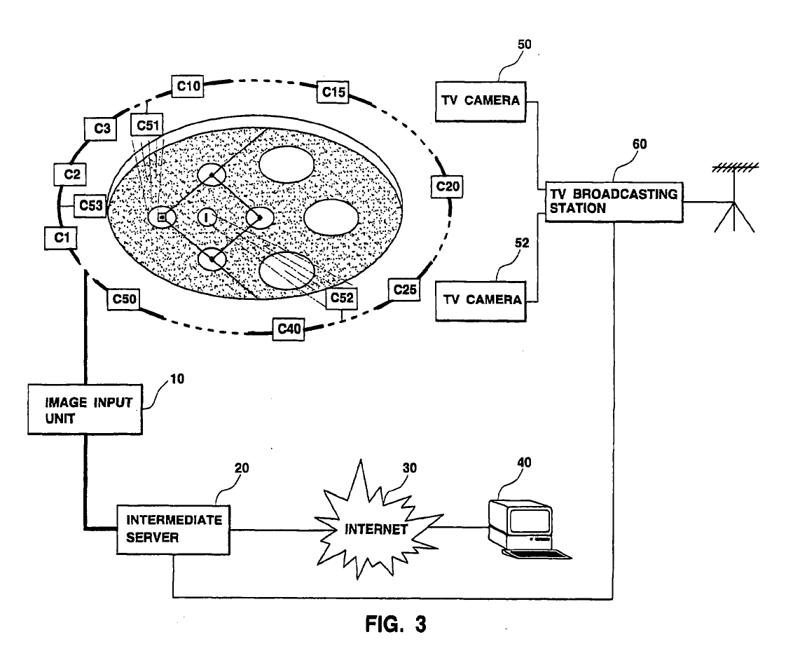

FIG. 3 is a block diagram for illustrating an online relay-broadcasting system in accordance with another embodiment of the present invention.

As shown in FIG. 3, the online relay-broadcasting system in accordance with the second embodiment of the present invention comprises: a plurality of digital cameras C1˜C53 set up around a stadium; an image input unit 10 for receiving images output from the cameras C1˜C53; an intermediate server 20 for not only re-setting to selectively transmit the images input from the image input unit according to requests of consumers who keeps in contact on the internet, but also receiving and transmitting relay-broadcasting signals input from a TV broadcasting station 60 on the internet, and computers 40 for enabling consumers to receive images of TV programs and select images output through the intermediate server 20 on the internet

Thus, all the images broadcasted by the TV broadcasting station 60 are also transmitted to the intermediate server 20 along with the images output from the first through fifty-third digital cameras C1˜C53, so that the consumers can enjoy all of the online images on their computers 40 without a TV antenna.

Therefore, there is an advantage in the online relay-broadcasting system of the present invention in that consumers can enjoy the reality of a game by directly editing all the online images captured and output by a plurality of digital cameras set up around a stadium, regardless of time and distance

In addition, if the digital cameras set up around the stadium are always in its operational state, a variety of events taking place in the stadium can be always viewed by a number of consumers regardless of a preset time or a predetermined schedule of a game to be broadcasted by a TV broadcasting station, preventing disastrous accidents and robbery or enabling consumers to utilize the online relay-broadcasting system for the purpose of meeting or chatting with others who is at a predetermined position of the stadium.

Besides, there is another advantage in the online relay-broadcasting system of the present invention in that consumers can enjoy viewing three-dimensional dynamic images captured by a plurality of digital cameras as they are re-set to sequentially transmit images showing around the stadium.

On the other hand, the online relay-broadcasting system of the present invention is also advantageous in enabling consumers to directly select one camera out of a plurality of digital cameras set up around a stadium to see a desired image, reducing labor force and cost necessary for the relay-broadcasting stage.

Having described a preferred embodiment of the invention with reference to the accompanying drawings, it is to be understood that the invention is not limited to the aforementioned precise embodiment, and that various changes and modifications may be effected therein by one skilled in the art without departing from the scope or spirit of the invention as defined in the appended claims.

What is claimed is:

1. An online relay-broadcasting system comprising:
a plurality of digital cameras set up around a stadium;
an image input unit for receiving images output from the cameras;
an intermediate server for re-setting to selectively transmit the images input from the image input unit according to requests of consumers contacting on the internet; and
a computer for enabling consumers to receive images output from a TV relay-broadcasting station and select images transmitted through the intermediate server on the internet.

2. An online relay-broadcasting system comprising:
a plurality of digital cameras set up around a stadium;
an image input unit for receiving images output from the cameras;
an intermediate server for not only re-set to selectively transmit the images input from the image input unit according to requests of consumers contacting on the internet, but also receiving and transmitting the relay-broadcasting signals input from a TV broadcasting station on the internet; and
a computer for enabling consumers to receive images output from a TV broadcasting station and select images transmitted through the intermediate server on the internet.

3. The system, as defined in claim 1 or 2, wherein a predetermined number of the digital cameras are set up around a stadium, focusing on an identical object at a predetermined angle, and another predetermined number of the digital cameras respectively, zooming in to take images of a predetermined object.

4. The system, as defined in claim 1 or 2, wherein the intermediate server is constructed to transmit three-dimensional dynamic images showing around a stadium by varying a predetermined interval of time to sequentially re-set the images captured by a plurality of digital cameras.

5. The system, as defined in claim 1 or 2, wherein the intermediate server can individually control a plurality of digital cameras with the image input unit for relay-broadcastings.

6. The system, as defined in claim 1 or 2, wherein the digital cameras and the image input unit are inter-connected in a cable or wireless networking method.

7. The system, as defined in claim 1 or 2, wherein the consumers' computer has functions of:
selecting a desired camera out of a plurality of cameras set up around a stadium;
editing relaying images; and
selecting and viewing three-dimensional dynamic images.
